(19) United States
(12) Patent Application Publication
(10) Pub. No.: US 2024/0244372 A1
(43) Pub. Date: Jul. 18, 2024

(54) RECYCLABLE PATCH-TYPE BONE CONDUCTION EARPHONE

(71) Applicant: ASTI GLOBAL INC., TAIWAN, Taichung City (TW)

(72) Inventors: CHIEN-SHOU LIAO, Taichung City (TW); YING-CHIEH CHEN, Taichung City (TW)

(21) Appl. No.: 18/544,365

(22) Filed: Dec. 18, 2023

Related U.S. Application Data
(60) Provisional application No. 63/439,832, filed on Jan. 18, 2023.
(60) Provisional application No. 63/439,829, filed on Jan. 18, 2023.

(51) Int. Cl. H04R 5/033; H04R 1/10

(52) U.S. Cl. CPC H04R 5/0335; H04R 1/1066; H04R 1/1075; H04R 1/1083; H04R 1/1091; H04R 2201/105; H04R 2420/07; H04R 2460/01; H04R 2460/13

(57) ABSTRACT

A recyclable patch-type bone conduction earphone includes a casing structure, a circuit substrate, a control module, an audio signal receiving module, a wireless signal transmission module, a bone conduction module and a power supply module. The audio signal receiving module is configured to receive an environmental audio signal. The wireless signal transmission module is configured for wirelessly receiving a predetermined audio signal. The bone conduction module is configured to convert the predetermined audio signal into a predetermined vibration signal. The circuit substrate, the control module, the audio signal receiving module, the wireless signal transmission module and the bone conduction module can cooperate with each other to form an electronic assembly structure that is able to be recycled, so that the electronic assembly structure can be configured to be used in a new recyclable patch-type bone conduction earphone through a recycling process or related processing steps.

### CROSS-REFERENCE TO RELATED PATENT APPLICATION

This application claims the benefit of priorities to the U.S. Provisional Patent Application Ser. No. 63/439,832, filed on Jan. 18, 2023, and Ser. No. 63/439,829 filed on Jan. 18, 2023, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a patch-type bone conduction earphone, and more particularly to a recyclable patch-type bone conduction earphone.

### BACKGROUND OF THE DISCLOSURE

In the related art, a wireless earphone can be an electronic device placed in a user's ear for the user to receive audio signals wirelessly. However, the internal structure of the wireless earphone is relatively complex and cannot be disassembled, so that the wireless earphone cannot be recycled and reused, which will have an adverse impact on the ecological environment.

### SUMMARY OF THE DISCLOSURE

In response to the above-referenced technical inadequacy, the present disclosure provides a recyclable patch-type bone conduction earphone.

In order to solve the above-mentioned problems, one of the technical aspects adopted by the present disclosure is to provide a recyclable patch-type bone conduction earphone, which includes a casing structure, a circuit substrate, a control module, an audio signal receiving module, a wireless signal transmission module, a bone conduction module and a power supply module. The casing structure includes a carrier base and a covering casing disposed on the carrier base. The circuit substrate is detachably disposed on a top portion of the carrier base. The control module is disposed on the circuit substrate and electrically connected to the circuit substrate. The audio signal receiving module is disposed on the circuit substrate and electrically connected to the control module, and the audio signal receiving module is configured to receive an environmental audio signal. The wireless signal transmission module is disposed on the circuit substrate and electrically connected to the control module, and the wireless signal transmission module is configured for wirelessly receiving a predetermined audio signal provided by a portable electronic device. The bone conduction module is disposed on the circuit substrate and electrically connected to the control module, and the bone conduction module is configured to convert the predetermined audio signal received by the wireless signal transmission module into a predetermined vibration signal. The power supply module is electrically connected to the control module, and the power supply module is configured to provide power to the control module, the audio signal receiving module, the wireless signal transmission module and the bone conduction module. The carrier base has an adhesive layer disposed on a bottom portion thereof and a removable protective layer attached to the adhesive layer. The circuit substrate, the control module, the audio signal receiving module, the wireless signal transmission module and the bone conduction module are all covered by the covering casing, so that the circuit substrate, the control module, the audio signal receiving module, the wireless signal transmission module and the bone conduction module are all received inside the casing structure. When the removable protective layer is removed from the adhesive layer to expose the adhesive layer, the recyclable patch-type bone conduction earphone is attached to a user's facial skin near ears through the adhesive layer. The circuit substrate, the control module, the audio signal receiving module, the wireless signal transmission module and the bone conduction module cooperate with each other to form an electronic assembly structure that is able to be recycled.

In order to solve the above-mentioned problems, another one of the technical aspects adopted by the present disclosure is to provide a recyclable patch-type bone conduction earphone, which includes a casing structure, a circuit substrate, a control module, an audio signal receiving module, a wireless signal transmission module, a bone conduction module and a power supply module. The casing structure includes a carrier base and a covering casing disposed on the carrier base. The circuit substrate is detachably disposed on a top portion of the carrier base. The control module is disposed on the circuit substrate and electrically connected to the circuit substrate. The audio signal receiving module is disposed on the circuit substrate and electrically connected to the control module, and the audio signal receiving module is configured to receive an environmental audio signal. The wireless signal transmission module is disposed on the circuit substrate and electrically connected to the control module, and the wireless signal transmission module is configured for wirelessly receiving a predetermined audio signal provided by a portable electronic device. The bone conduction module is disposed on the circuit substrate and electrically connected to the control module, and the bone conduction module is configured to convert the predetermined audio signal received by the wireless signal transmission module into a predetermined vibration signal. The power supply module is electrically connected to the control module, and the power supply module is configured to provide power to the control module, the audio signal receiving module, the wireless signal transmission module and the bone conduction module. The carrier base has an adhesive layer disposed on a bottom portion thereof and a removable protective layer attached to the adhesive layer. The circuit substrate, the control module, the audio signal receiving module, the wireless signal transmission module and the bone conduction module cooperate with each other to form an electronic assembly structure that is able to be recycled.

In order to solve the above-mentioned problems, yet another one of the technical aspects adopted by the present disclosure is to provide a recyclable patch-type bone conduction earphone, which includes a casing structure, a circuit substrate, a control module, an audio signal receiving module, a wireless signal transmission module, a bone conduction module and a power supply module. The casing structure includes a carrier base and a covering casing disposed on the carrier base. The circuit substrate is detachably disposed on a top portion of the carrier base. The control module is disposed on the circuit substrate and electrically connected to the circuit substrate. The audio signal receiving module is disposed on the circuit substrate and electrically connected to the control module, and the audio signal receiving module is configured to receive an environmental audio signal. The wireless signal transmission module is disposed on the circuit substrate and electrically connected to the control module, and the wireless signal transmission module is configured for wirelessly receiving a predetermined audio signal provided by a portable electronic device. The bone conduction module is disposed on the circuit substrate and electrically connected to the control module, and the bone conduction module is configured to convert the predetermined audio signal received by the wireless signal transmission module into a predetermined vibration signal. The power supply module is electrically connected to the control module, and the power supply module is configured to provide power to the control module, the audio signal receiving module, the wireless signal transmission module and the bone conduction module. The covering casing has a plurality of through openings corresponding to the audio signal receiving module, and the audio signal receiving module is configured to receive the environmental audio signal through the through openings.

Therefore, in the recyclable patch-type bone conduction earphone provided by the present disclosure, by virtue of “the audio signal receiving module being configured to receive an environmental audio signal,” “the wireless signal transmission module being configured for wirelessly receiving a predetermined audio signal provided by a portable electronic device,” “the bone conduction module being configured to convert the predetermined audio signal received by the wireless signal transmission module into a predetermined vibration signal” and “the power supply module being configured to provide power to the control module, the audio signal receiving module, the wireless signal transmission module and the bone conduction module,” when the recyclable patch-type bone conduction earphone is attached to the user's facial skin near the ears, the user can transmit (send or receive) audio signals through the recyclable patch-type bone conduction earphone. More particularly, the circuit substrate, the control module, the audio signal receiving module, the wireless signal transmission module and the bone conduction module can cooperate with each other to form an electronic assembly structure that is able to be recycled, so that the electronic assembly structure can be configured to be used in a new recyclable patch-type bone conduction earphone through a recycling process or related processing steps.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective assembled view of a recyclable patch-type bone conduction earphone provided by a first embodiment of the present disclosure;

FIG. 2 is a schematic perspective exploded view of the recyclable patch-type bone conduction earphone provided by the first embodiment of the present disclosure;

FIG. 3 is a schematic top view of the recyclable patch-type bone conduction earphone provided by the first embodiment of the present disclosure;

FIG. 4 is a schematic cross-sectional view taken along line IV-IV of FIG. 3;

FIG. 5 is a functional block diagram of the recyclable patch-type bone conduction earphone provided by the first embodiment of the present disclosure;

FIG. 6 is a functional block diagram of the recyclable patch-type bone conduction earphone provided by a second embodiment of the present disclosure;

FIG. 7 is a flowchart of a recycling method for the recyclable bone conduction earphones provided by a third embodiment of the present disclosure;

FIG. 8 is a schematic view of step S100 and step S104 of the recycling method for the recyclable bone conduction earphones provided by the third embodiment of the present disclosure;

FIG. 9 is a schematic view of step S106 and step S108 of the recycling method for the recyclable bone conduction earphones provided by the third embodiment of the present disclosure; and

FIG. 10 is a schematic view of step S112 of the recycling method for the recyclable bone conduction earphones provided by the third embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

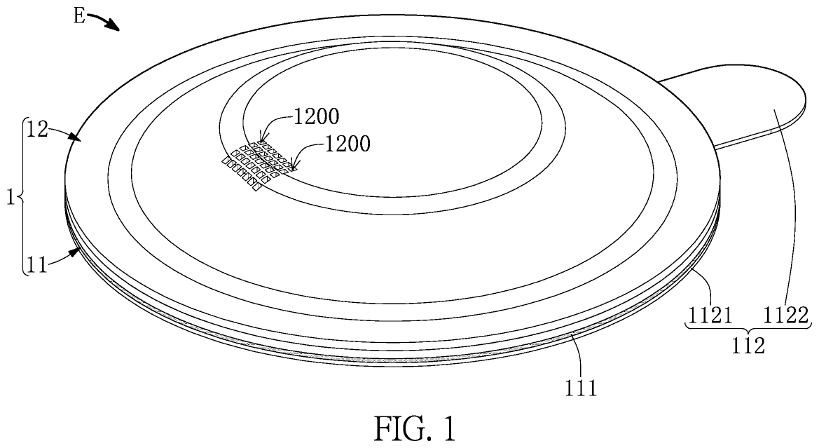

Referring to FIG. 1 to FIG. 5, a first embodiment of the present disclosure provides a recyclable patch-type bone conduction earphone E (or a recyclable and reusable patch-type bone conduction headphone), which includes a casing structure 1 (or a shell structure), a circuit substrate 2, a control module 3, an audio signal receiving module 4 (or a sound receiving module), a wireless signal transmission module 5 (or a signal transmitting module), a bone conduction module 6 and a power supply module 7. It should be noted that the recyclable patch-type bone conduction earphone E does not have an electrical connector or a wireless charging module for charging.

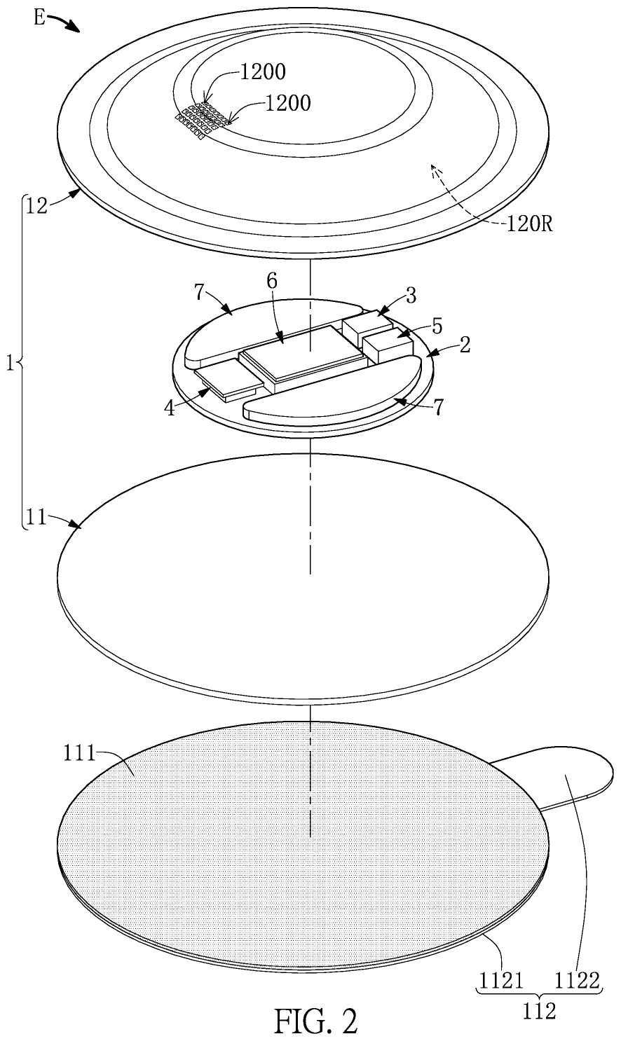

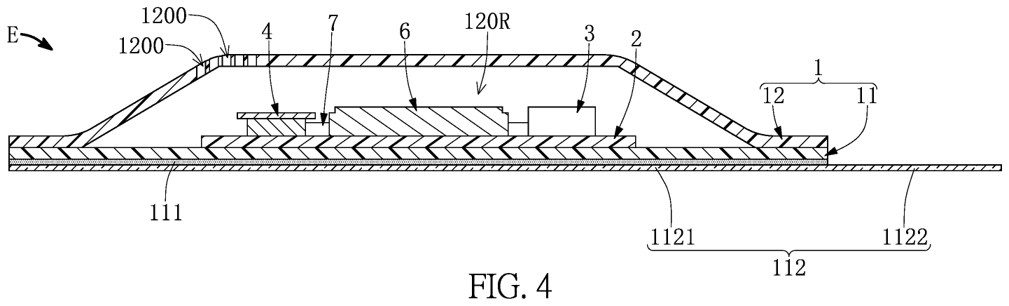

Firstly, referring to FIG. 1, FIG. 2 and FIG. 4, the casing structure 1 includes a carrier base 11 (or a carrying base, or a base casing, or a bottom casing) and a covering casing 12 (or a top casing) disposed on the carrier base 11, and the circuit substrate 2, the control module 3, the audio signal receiving module 4, the wireless signal transmission module 5 and the bone conduction module 6 are all covered by the covering casing 12, so that the circuit substrate 2, the control module 3, the audio signal receiving module 4, the wireless signal transmission module 5 and the bone conduction module 6 are all received or wrapped inside the casing structure 1. In addition, the circuit substrate 2, the control module 3, the audio signal receiving module 4, the wireless signal transmission module 5 and the bone conduction module 6 are not in contact with the covering casing 12 and separate from the covering casing 12 through the air layer, so that when the covering casing 12 is impacted by the external force, the circuit substrate 2, the control module 3, the audio signal receiving module 4, the wireless signal transmission module 5 and the bone conduction module 6 can avoid indirect impact from external force. For example, the carrier base 11 has an adhesive layer 111 disposed on a bottom portion thereof and a removable protective layer 112 attached to the adhesive layer 111. Moreover, the covering casing 12 can be detachably (such as using an exposed buckle structure), non-detachably (such as using a built-in buckle structure), or integrally disposed on the carrier base 11, and the covering casing 12 has a plurality of through openings 1200 (can be shaped as any shape) corresponding to the audio signal receiving module 4. In addition, the covering casing 12 has a concave groove 120R (or an accommodation groove) for completely accommodating the circuit substrate 2, the control module 3, the audio signal receiving module 4, the wireless signal transmission module 5 and the bone conduction module 6, and a depth of the concave groove 120R is greater than a total stacking height of the circuit substrate 2 and one of the control module 3, the audio signal receiving module 4, the wireless signal transmission module 5 and the bone conduction module 6 (that is to say, the control module 3, the audio signal receiving module 4, the wireless signal transmission module 5 and the bone conduction module 6 will not push against or contact the inner surface of the concave groove 120R). It should be noted that the removable protective layer 112 has a covering portion 1121 and an extending portion 1122, the covering portion 1121 of the removable protective layer 112 can be configured to completely cover the adhesive layer 111, and the extending portion 1122 of the removable protective layer 112 can be connected to the covering portion 1121 and separate from the adhesive layer 111. However, the aforementioned details are disclosed for exemplary purposes only, and are not meant to limit the scope of the present disclosure.

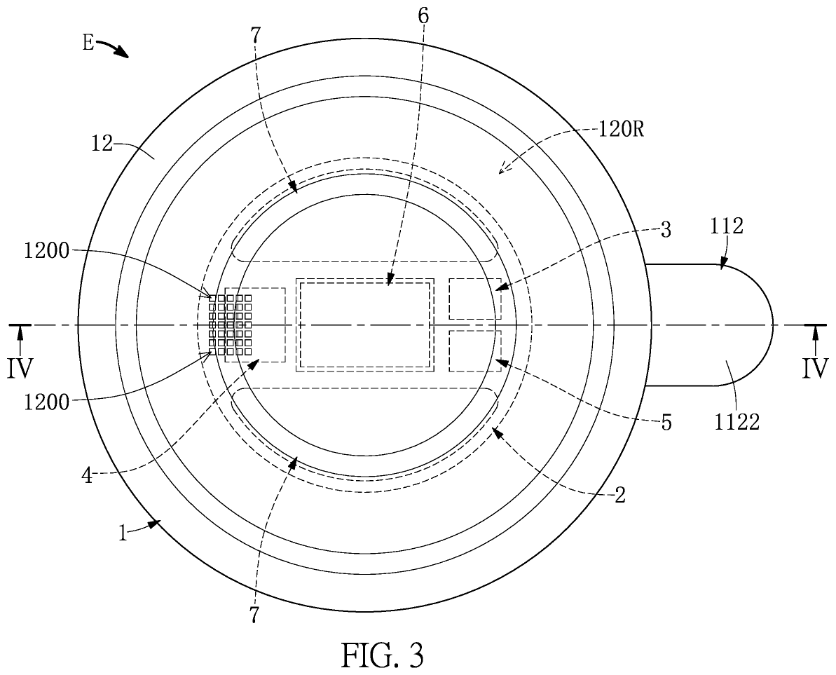

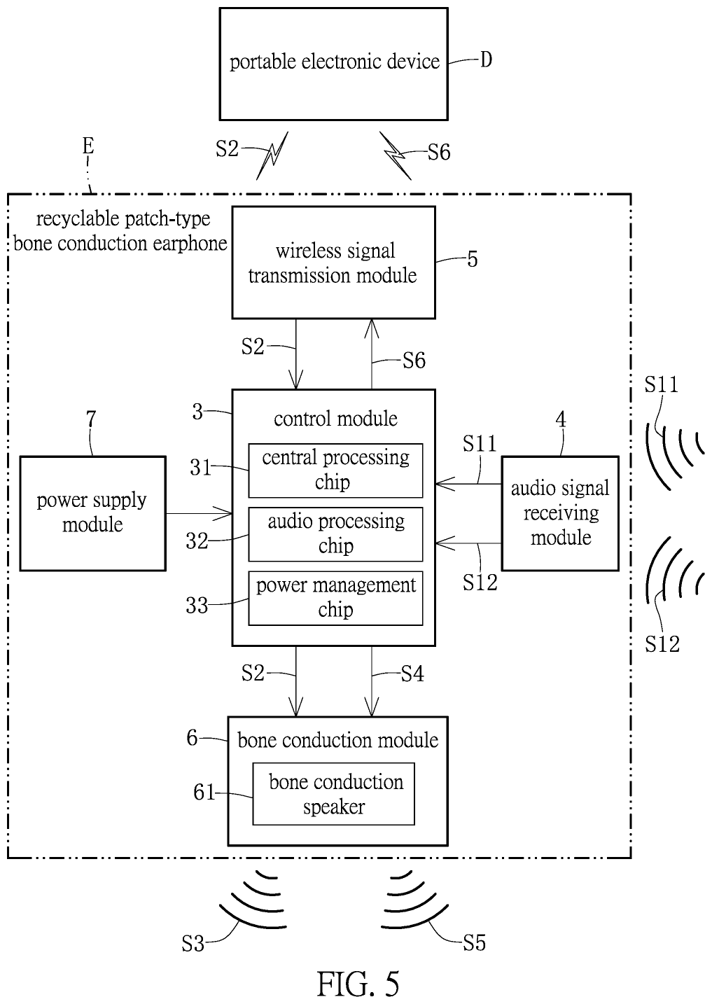

Furthermore, referring to FIG. 2, FIG. 3 and FIG. 5, the circuit substrate 2 is detachably disposed on a top portion of the carrier base 11, the control module 3 is disposed on the circuit substrate 2 and electrically connected to the circuit substrate 2, the audio signal receiving module 4 is disposed on the circuit substrate 2 and electrically connected to the control module 3, and the audio signal receiving module 4 can be configured to receive an environmental audio signal (or an environmental sound such as an irregular audio signal or a relatively regular audio signal). For example, the control module 3 may include a central processing chip 31, an audio processing chip 32 and a power management chip 33, and the central processing chip 31 (such as central processing unit (CPU)), the audio processing chip 32 (such as digital signal processor (DSP)) and the power management chip 33 (such as power management IC (PMIC)) can cooperate with each other and be packaged together to form an SoC (System on Chip) packaging structure. Moreover, the audio signal receiving module 4 can be a microelectromechanical microphone chip (i.e., MEMS microphone chip), an electret condenser microphone chip (i.e., ECM chip) or any miniaturized receiver, and the audio signal receiving module 4 can be configured to receive an irregular audio signal S11 (such as user's voice or voice of others) or a relatively regular audio signal S12 (i.e., more regular sound or near-regular environmental noise, such as engine sounds from vehicles, motor sounds from home appliances, or any sounds from any electronic products). It should be noted that the relatively regular audio signal S12 can also be received without using the audio signal receiving module 4, but by using another independently configured miniature microphone chip (not shown). In addition, the audio signal receiving module 4 can be configured to receive the environmental audio signal through the through openings 1200, thereby increasing the transmission efficiency of the environmental audio signal. However, the aforementioned details are disclosed for exemplary purposes only, and are not meant to limit the scope of the present disclosure.

Moreover, referring to FIG. 2, FIG. 3 and FIG. 5, the wireless signal transmission module 5 is disposed on the circuit substrate 2 and electrically connected to the control module 3, and the wireless signal transmission module 5 can be configured for wirelessly receiving a predetermined audio signal S2 provided by a portable electronic device D (such as smartphone or laptop). For example, the wireless signal transmission module 5 can be a Bluetooth chip or a radio frequency identification (RFID) chip, and the recyclable patch-type bone conduction earphone E can be wirelessly connected to the portable electronic device D that is configured to provide the predetermined audio signal S2 through the wireless signal transmission module 5. More particularly, when the audio signal receiving module 4 is configured to receive the irregular audio signal S11 (such as the voice of the user U), the irregular audio signal S11 received by the audio signal receiving module 4 can be transmitted to the portable electronic device D through the wireless signal transmission module 5, so that the recyclable patch-type bone conduction earphone E can be used as a miniature wireless earphone microphone. In addition, when the audio signal receiving module 4 is configured to receive the relatively regular audio signal S12 (such as low-frequency and regular ambient noise), the relatively regular audio signal S12 received by the audio signal receiving module 4 can be processed by the audio processing chip 32 to provide an inverse audio signal S4 (or a reverse acoustic signal) that is opposite to a waveform of the relatively regular audio signal S12 (such as a waveform with the opposite phase and the same amplitude as the relatively regular audio signal S12). However, the aforementioned details are disclosed for exemplary purposes only, and are not meant to limit the scope of the present disclosure.

In addition, referring to FIG. 2, FIG. 3 and FIG. 5, the bone conduction module 6 is disposed on the circuit substrate 2 and electrically connected to the control module 3, and the bone conduction module 6 can be configured to convert the predetermined audio signal S2 received by the wireless signal transmission module 5 into a predetermined vibration signal S3. For example, the bone conduction module 6 may include a bone conduction speaker 61 (or a bone conduction speaker chip), the bone conduction speaker 61 can transmit sound wave signals by applying vibration to the user's bones, and the bone conduction speaker 61 can be a voice coil speaker or a piezoelectric speaker. More particularly, when the wireless signal transmission module 5 is configured to receive the predetermined audio signal S2, the bone conduction speaker 61 can be configured to convert the predetermined audio signal S2 received by the wireless signal transmission module 5 into the predetermined vibration signal S3. In addition, when the relatively regular audio signal S12 is processed by the audio processing chip 32 to provide the inverse audio signal S4 that is opposite to the waveform of the relatively regular audio signal S12, the bone conduction speaker 61 can be configured to convert the inverse audio signal S4 provided by the audio processing chip 32 into a noise cancellation vibration signal S5 (or an active noise cancellation vibration, or an active noise reduction vibration) so as to reduce the impact of the relatively regular audio signal S12 (such as low-frequency and regular environmental noise) on the user U. However, the aforementioned details are disclosed for exemplary purposes only, and are not meant to limit the scope of the present disclosure.

Furthermore, referring to FIG. 2, FIG. 3 and FIG. 5, the power supply module 7 is electrically connected to the control module 3, and the power supply module 7 can be configured to provide power to the control module 3, the audio signal receiving module 4, the wireless signal transmission module 5 and the bone conduction module 6. For example, the power supply module 7 can be any type of detachable thin film solar cell, such as a silicon-based thin film solar cell, a copper indium gallium selenide (CIGS) thin film solar cell or a cadmium telluride (CdTe) thin film solar cell. In addition, the power supply module 7 can be a disposable thin film battery or a rechargeable thin film battery, and a power-related information signal S6 (such as remaining battery status or estimated remaining battery life) of the power supply module 7 can be transmitted to the portable electronic device D through the wireless signal transmission module 5 for the user's reference. It should be noted that the present disclosure can take two power supply modules 7 arranged symmetrically as an example for illustration in FIG. 2 and FIG. 3 (that is to say, the number of the power supply module 7 can also be multiple). However, the aforementioned details are disclosed for exemplary purposes only, and are not meant to limit the scope of the present disclosure.

### Second Embodiment

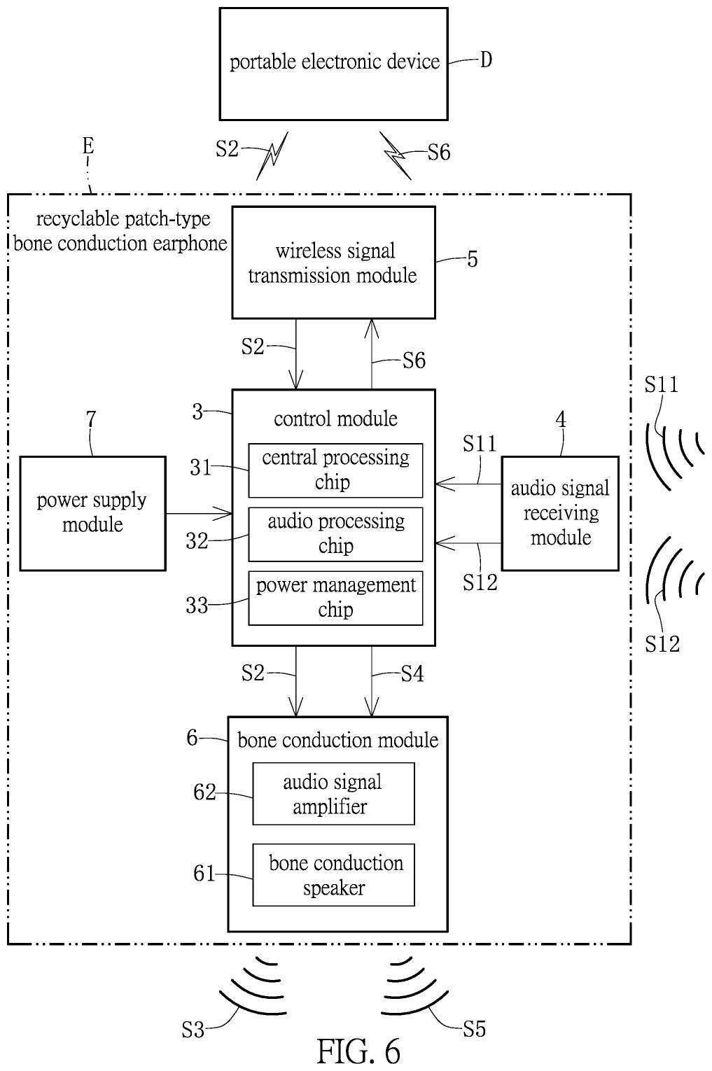

Referring to FIG. 6, a second embodiment of the present disclosure provides a recyclable patch-type bone conduction earphone E, which includes a casing structure 1, a circuit substrate 2, a control module 3, an audio signal receiving module 4, a wireless signal transmission module 5, a bone conduction module 6 and a power supply module 7. Comparing FIG. 6 with FIG. 5, the main difference between the second embodiment and the first embodiment is as follows: in the second embodiment, the bone conduction module 6 includes a bone conduction speaker 61 (or a bone conduction speaker chip) and an audio signal amplifier 62 (or an audio signal amplifier chip) electrically connected between the bone conduction speaker 61 and the control module 3. For example, the audio signal amplifier 62 maybe an audio power amplifier. However, the aforementioned details are disclosed for exemplary purposes only, and are not meant to limit the scope of the present disclosure.

For example, when the wireless signal transmission module 5 is configured to receive the predetermined audio signal S2, the audio signal amplifier 62 can be configured to amplify the predetermined audio signal S2 received by the wireless signal transmission module 5, and the bone conduction speaker 61 can be configured to convert the predetermined audio signal S2 that is amplified by the audio signal amplifier 62 into the predetermined vibration signal S3 (i.e., an amplified predetermined vibration signal). However, the aforementioned details are disclosed for exemplary purposes only, and are not meant to limit the scope of the present disclosure.

For example, when the relatively regular audio signal S12 is processed by the audio processing chip 32 to provide the inverse audio signal S4 that is opposite to the waveform of the relatively regular audio signal S12, the audio signal amplifier 62 can be configured to amplify the inverse audio signal S4 that is provided by the audio processing chip 32, and the bone conduction speaker 61 can be configured to convert the inverse audio signal S4 that is amplified by the audio signal amplifier 62 into a noise cancellation vibration signal S5 (i.e., an amplified noise cancellation vibration signal). However, the aforementioned details are disclosed for exemplary purposes only, and are not meant to limit the scope of the present disclosure.

### Third Embodiment

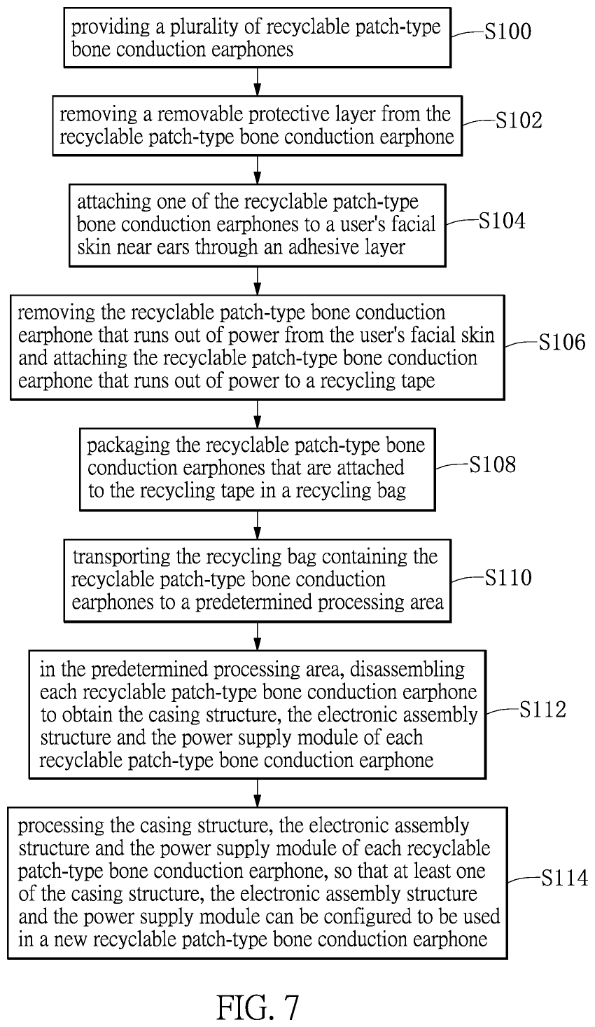

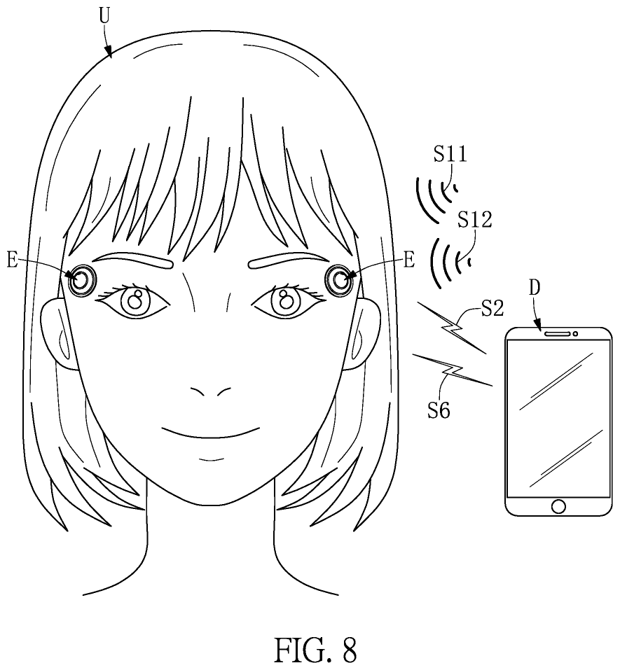

Referring to FIG. 7 to FIG. 10, a third embodiment of the present disclosure provides a recycling method for recyclable bone conduction earphones, which includes: firstly, providing a plurality of recyclable patch-type bone conduction earphones E (for example, referring to FIG. 1, FIG. 5 and FIG. 6, the recyclable patch-type bone conduction earphones E provided in the third embodiment may be the recyclable patch-type bone conduction earphones E provided in the first embodiment or the second embodiment, each of the recyclable patch-type bone conduction earphones E includes a casing structure 1, an electronic assembly structure G and a power supply module 7, the casing structure 1 has an adhesive layer 111 disposed on a bottom portion thereof and a removable protective layer 112 attached to the adhesive layer 111, and the electronic assembly structure G and the power supply module 7 are received inside the casing structure 1) (step S100); next, referring to FIG. 1, FIG. 7 and FIG. 8, removing the removable protective layer 112 from the adhesive layer 111 (or from the recyclable patch-type bone conduction earphone E) (step S102), and attaching one of the recyclable patch-type bone conduction earphones E to a user's facial skin (the facial skin of the user U) near ears through the adhesive layer 111 (step S104); then, referring to FIG. 7, FIG. 8 and

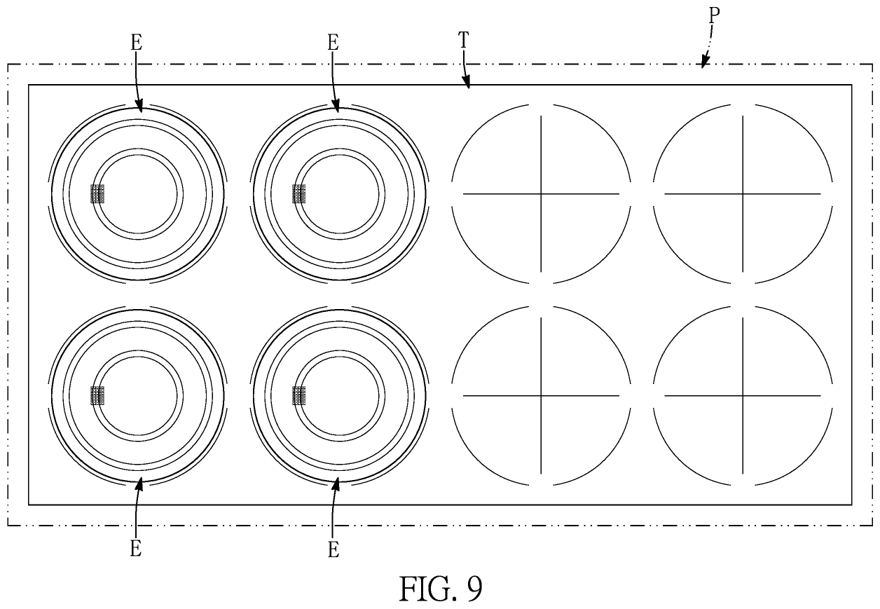

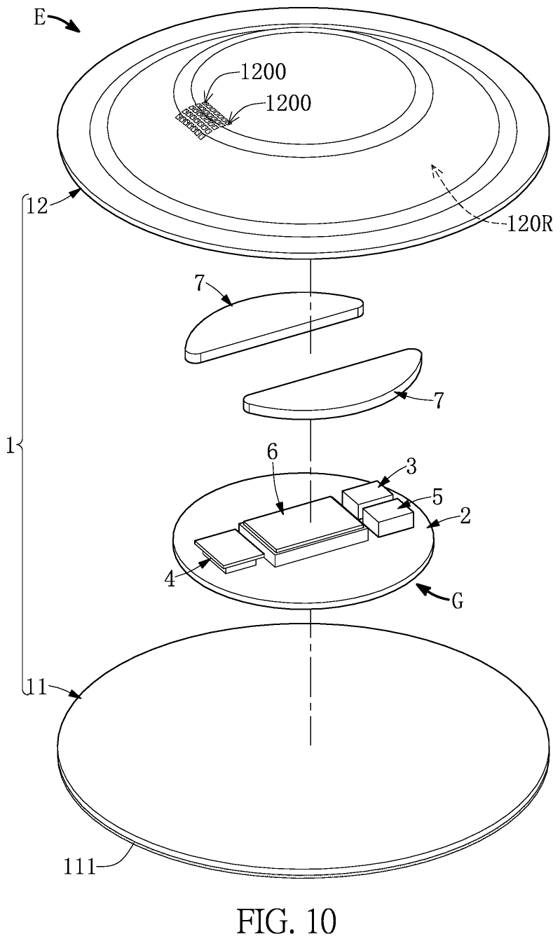

FIG. 9, when power of the recyclable patch-type bone conduction earphone E attached to the user's facial skin is exhausted (for example, the recyclable patch-type bone conduction earphone E can be used by the user U for several hours to several days depending on the capacitance of the power supply module 7), removing the recyclable patch-type bone conduction earphone E that runs out of power from the user's facial skin and attaching the recyclable patch-type bone conduction earphone E that runs out of power to a recycling tape T (for example, the recyclable patch-type bone conduction earphones E can be attached to the same side or two opposite sides of the recycling tape T) (step S106); afterward, referring to FIG. 7, FIG. 8 and FIG. 9, when a quantity of the recyclable patch-type bone conduction earphones E attached to the recycling tape T reaches a predetermined target (for example, the recyclable patch-type bone conduction earphones E are respectively attached to a plurality of receiving areas of the recycling tape T), packaging the recyclable patch-type bone conduction earphones E that are attached to the recycling tape T in a recycling bag P (step S108); next, referring to FIG. 7, FIG. 9 and FIG. 10, transporting the recycling bag P containing the recyclable patch-type bone conduction earphones E to a predetermined processing area (such as a recycling site or a disposal site) (step S110), and in the predetermined processing area, disassembling each of the recyclable patch-type bone conduction earphones E that are removed from the recycling bag P to obtain the casing structure 1, the electronic assembly structure G and the power supply module 7 of each of the recyclable patch-type bone conduction earphones E (step S112); then, referring to FIG. 7 and FIG. 10, processing (such as cleaning, disinfecting, electrical testing, functional testing or any related processing) the casing structure 1, the electronic assembly structure G (at least including the circuit substrate 2, the control module 3, the audio signal receiving module 4, the wireless signal transmission module 5 and the bone conduction module 6) and the power supply module 7 of each of the recyclable patch-type bone conduction earphones E, so that at least one of the casing structure 1, the electronic assembly structure G and the power supply module 7 can be configured to be used in a new recyclable patch-type bone conduction earphone E (step S114).

For example, as shown in FIG. 8, in the step S102 of removing the removable protective layer 112 from the adhesive layer 111, when the removable protective layer 112 is removed from the adhesive layer 111 to expose the adhesive layer 111, the recyclable patch-type bone conduction earphone E can be attached to the facial skin of the user U near ears through the adhesive layer 111 once or repeatedly. However, the aforementioned details are disclosed for exemplary purposes only, and are not meant to limit the scope of the present disclosure.

For example, as shown in FIG. 10, the electronic assembly structure G can be disposed on the top portion of the carrier base 11 through a position-limiting structure (not shown in the figure, such as an adhesive layer, a groove structure, a clamping structure or a positioning structure) that is located at a bottom portion of the circuit substrate 2, and the electronic assembly structure G does not contact the covering casing 12 (that is to say, when the recyclable patch-type bone conduction earphones E are to be disassembled, the electronic assembly structure G will not be hindered or limited by the covering casing 12 at all), so that the electronic assembly structure G can be easily separated from the carrier base 11 by using appropriate force or tools. In addition, the circuit substrate 2, the control module 3, the audio signal receiving module 4, the wireless signal transmission module 5 and the bone conduction module 6 can cooperate with each other to form an electronic assembly structure G that is able to be recycled, so that the electronic assembly structure G can be configured to be used in a new recyclable patch-type bone conduction earphone through a recycling process or related processing steps. However, the aforementioned details are disclosed for exemplary purposes only, and are not meant to limit the scope of the present disclosure.

### Beneficial Effects of the Embodiments

In conclusion, in the recyclable patch-type bone conduction earphone E provided by the present disclosure, by virtue of “the audio signal receiving module 4 being configured to receive an environmental audio signal,” “the wireless signal transmission module 5 being configured for wirelessly receiving a predetermined audio signal S2 provided by a portable electronic device D,” “the bone conduction module 6 being configured to convert the predetermined audio signal S2 received by the wireless signal transmission module 5 into a predetermined vibration signal S3” and “the power supply module 7 being configured to provide power to the control module 3, the audio signal receiving module 4, the wireless signal transmission module 5 and the bone conduction module 6,” when the recyclable patch-type bone conduction earphone E is attached to the user's facial skin near the ears, the user U can transmit (send or receive) audio signals through the recyclable patch-type bone conduction earphone E. More particularly, the circuit substrate 2, the control module 3, the audio signal receiving module 4, the wireless signal transmission module 5 and the bone conduction module 6 can cooperate with each other to form an electronic assembly structure G that is able to be recycled, so that the electronic assembly structure G can be configured to be used in a new recyclable patch-type bone conduction earphone through a recycling process or related processing steps.

Furthermore, in the recyclable patch-type bone conduction earphone E provided by the present disclosure, by virtue of “removing the recyclable patch-type bone conduction earphone E that runs out of power from the user's facial skin and attaching the recyclable patch-type bone conduction earphone E that runs out of power to a recycling tape T,” “packaging the recyclable patch-type bone conduction earphones E that are attached to the recycling tape T in a recycling bag P,” “transporting the recycling bag P containing the recyclable patch-type bone conduction earphones E to a predetermined processing area” “in the predetermined processing area, disassembling each of the recyclable patch-type bone conduction earphones E that are removed from the recycling bag P to obtain the casing structure 1, the electronic assembly structure G and the power supply module 7 of each of the recyclable patch-type bone conduction earphones E” and “processing the casing structure 1, the electronic assembly structure G and the power supply module 7 of each of the recyclable patch-type bone conduction earphones E,” at least one of the casing structure 1, the electronic assembly structure G and the power supply module 7 can be configured to be used in a new recyclable patch-type bone conduction earphone E.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A recyclable patch-type bone conduction earphone, comprising:
a casing structure including a carrier base and a covering casing disposed on the carrier base;
a circuit substrate detachably disposed on a top portion of the carrier base;
a control module disposed on the circuit substrate and electrically connected to the circuit substrate;
an audio signal receiving module disposed on the circuit substrate and electrically connected to the control module, wherein the audio signal receiving module is configured to receive an environmental audio signal;
a wireless signal transmission module disposed on the circuit substrate and electrically connected to the control module, wherein the wireless signal transmission module is configured for wirelessly receiving a predetermined audio signal provided by a portable electronic device;
a bone conduction module disposed on the circuit substrate and electrically connected to the control module, wherein the bone conduction module is configured to convert the predetermined audio signal received by the wireless signal transmission module into a predetermined vibration signal; and
a power supply module electrically connected to the control module, wherein the power supply module is configured to provide power to the control module, the audio signal receiving module, the wireless signal transmission module and the bone conduction module;
wherein the carrier base has an adhesive layer disposed on a bottom portion thereof and a removable protective layer attached to the adhesive layer;
wherein the circuit substrate, the control module, the audio signal receiving module, the wireless signal transmission module and the bone conduction module are all covered by the covering casing, so that the circuit substrate, the control module, the audio signal receiving module, the wireless signal transmission module and the bone conduction module are all received inside the casing structure;
wherein, when the removable protective layer is removed from the adhesive layer to expose the adhesive layer, the recyclable patch-type bone conduction earphone is attached to a user's facial skin near ears through the adhesive layer;
wherein the circuit substrate, the control module, the audio signal receiving module, the wireless signal transmission module and the bone conduction module cooperate with each other to form an electronic assembly structure that is able to be recycled.

2. The recyclable patch-type bone conduction earphone according to claim 1, wherein the covering casing is detachably or integrally disposed on the carrier base, the covering casing has a plurality of through openings corresponding to the audio signal receiving module, and the audio signal receiving module is configured to receive the environmental audio signal through the through openings;
wherein the covering casing has a concave groove for completely accommodating the circuit substrate, the control module, the audio signal receiving module, the wireless signal transmission module and the bone conduction module, and a depth of the concave groove is greater than a total stacking height of the circuit substrate and one of the control module, the audio signal receiving module, the wireless signal transmission module and the bone conduction module;
wherein the removable protective layer has a covering portion and an extending portion, the covering portion of the removable protective layer is configured to completely cover the adhesive layer, and the extending portion of the removable protective layer is connected to the covering portion and separate from the adhesive layer;
wherein the electronic assembly structure is disposed on the top portion of the carrier base through a position-limiting structure located at a bottom portion of the circuit substrate, and the electronic assembly structure does not contact the covering casing.

3. The recyclable patch-type bone conduction earphone according to claim 1,
wherein the control module includes a central processing chip, an audio processing chip and a power management chip, and the bone conduction module includes a bone conduction speaker;
wherein the audio signal receiving module is a microelectromechanical microphone chip or an electret condenser microphone chip, and the audio signal receiving module is configured to receive an irregular audio signal or a relatively regular audio signal;
wherein, when the audio signal receiving module is configured to receive the irregular audio signal, the irregular audio signal received by the audio signal receiving module is transmitted to the portable electronic device through the wireless signal transmission module;
wherein, when the audio signal receiving module is configured to receive the relatively regular audio signal, the relatively regular audio signal received by the audio signal receiving module is processed by the audio processing chip to provide an inverse audio signal that is opposite to a waveform of the relatively regular audio signal;
wherein the wireless signal transmission module is a Bluetooth chip or a radio frequency identification chip, and the recyclable patch-type bone conduction earphone is wirelessly connected to the portable electronic device that is configured to provide the predetermined audio signal through the wireless signal transmission module;
wherein, when the wireless signal transmission module is configured to receive the predetermined audio signal, the bone conduction speaker is configured to convert the predetermined audio signal received by the wireless signal transmission module into the predetermined vibration signal;
wherein, when the relatively regular audio signal is processed by the audio processing chip to provide the inverse audio signal that is opposite to the waveform of the relatively regular audio signal, the bone conduction speaker is configured to convert the inverse audio signal provided by the audio processing chip into a noise cancellation vibration signal;
wherein the power supply module is a disposable thin film battery, and a power-related information signal of the power supply module is transmitted to the portable electronic device through the wireless signal transmission module.

4. The recyclable patch-type bone conduction earphone according to claim 1, wherein the control module includes a central processing chip, an audio processing chip and a power management chip, and the bone conduction module includes a bone conduction speaker and an audio signal amplifier electrically connected between the bone conduction speaker and the control module:
wherein the audio signal receiving module is a microelectromechanical microphone chip or an electret condenser microphone chip, and the audio signal receiving module is configured to receive an irregular audio signal or a relatively regular audio signal;
wherein, when the audio signal receiving module is configured to receive the irregular audio signal, the irregular audio signal received by the audio signal receiving module is transmitted to the portable electronic device through the wireless signal transmission module;
wherein, when the audio signal receiving module is configured to receive the relatively regular audio signal, the relatively regular audio signal received by the audio signal receiving module is processed by the audio processing chip to provide an inverse audio signal that is opposite to a waveform of the relatively regular audio signal;
wherein the wireless signal transmission module is a Bluetooth chip or a radio frequency identification chip, and the recyclable patch-type bone conduction earphone is wirelessly connected to the portable electronic device that is configured to provide the predetermined audio signal through the wireless signal transmission module;
wherein, when the wireless signal transmission module is configured to receive the predetermined audio signal, the audio signal amplifier is configured to amplify the predetermined audio signal received by the wireless signal transmission module, and the bone conduction speaker is configured to convert the predetermined audio signal amplified by the audio signal amplifier into the predetermined vibration signal;
wherein, when the relatively regular audio signal is processed by the audio processing chip to provide the inverse audio signal that is opposite to the waveform of the relatively regular audio signal, the audio signal amplifier is configured to amplify the inverse audio signal provided by the audio processing chip, and the bone conduction speaker is configured to convert the inverse audio signal amplified by the audio signal amplifier into a noise cancellation vibration signal;
wherein the power supply module is a disposable thin film battery, and a power-related information signal of the power supply module is transmitted to the portable electronic device through the wireless signal transmission module.

5. A recyclable patch-type bone conduction earphone, comprising:
a casing structure including a carrier base and a covering casing disposed on the carrier base;
a circuit substrate detachably disposed on a top portion of the carrier base;
a control module disposed on the circuit substrate and electrically connected to the circuit substrate;
an audio signal receiving module disposed on the circuit substrate and electrically connected to the control module, wherein the audio signal receiving module is configured to receive an environmental audio signal;
a wireless signal transmission module disposed on the circuit substrate and electrically connected to the control module, wherein the wireless signal transmission module is configured for wirelessly receiving a predetermined audio signal provided by a portable electronic device;
a bone conduction module disposed on the circuit substrate and electrically connected to the control module, wherein the bone conduction module is configured to convert the predetermined audio signal received by the wireless signal transmission module into a predetermined vibration signal; and
a power supply module electrically connected to the control module, wherein the power supply module is configured to provide power to the control module, the audio signal receiving module, the wireless signal transmission module and the bone conduction module;
wherein the carrier base has an adhesive layer disposed on a bottom portion thereof and a removable protective layer attached to the adhesive layer;
wherein the circuit substrate, the control module, the audio signal receiving module, the wireless signal transmission module and the bone conduction module cooperate with each other to form an electronic assembly structure that is able to be recycled.

6. The recyclable patch-type bone conduction earphone according to claim 5,
wherein the covering casing is detachably or integrally disposed on the carrier base, the covering casing has a plurality of through openings corresponding to the audio signal receiving module, and the audio signal receiving module is configured to receive the environmental audio signal through the through openings;
wherein the covering casing has a concave groove for completely accommodating the circuit substrate, the control module, the audio signal receiving module, the wireless signal transmission module and the bone conduction module, and a depth of the concave groove is greater than a total stacking height of the circuit substrate and one of the control module, the audio signal receiving module, the wireless signal transmission module and the bone conduction module;
wherein the removable protective layer has a covering portion and an extending portion, the covering portion of the removable protective layer is configured to completely cover the adhesive layer, and the extending portion of the removable protective layer is connected to the covering portion and separate from the adhesive layer;
wherein the electronic assembly structure is disposed on the top portion of the carrier base through a position-limiting structure located at a bottom portion of the circuit substrate, and the electronic assembly structure does not contact the covering casing.

7. The recyclable patch-type bone conduction earphone according to claim 5,
herein the control module includes a central processing chip, an audio processing chip and a power management chip, and the bone conduction module includes a bone conduction speaker;
wherein the audio signal receiving module is a microelectromechanical microphone chip or an electret condenser microphone chip, and the audio signal receiving module is configured to receive an irregular audio signal or a relatively regular audio signal;
wherein, when the audio signal receiving module is configured to receive the irregular audio signal, the irregular audio signal received by the audio signal receiving module is transmitted to the portable electronic device through the wireless signal transmission module;
wherein, when the audio signal receiving module is configured to receive the relatively regular audio signal, the relatively regular audio signal received by the audio signal receiving module is processed by the audio processing chip to provide an inverse audio signal that is opposite to a waveform of the relatively regular audio signal;
wherein the wireless signal transmission module is a Bluetooth chip or a radio frequency identification chip, and the recyclable patch-type bone conduction earphone is wirelessly connected to the portable electronic device that is configured to provide the predetermined audio signal through the wireless signal transmission module;
wherein, when the wireless signal transmission module is configured to receive the predetermined audio signal, the bone conduction speaker is configured to convert the predetermined audio signal received by the wireless signal transmission module into the predetermined vibration signal;
wherein, when the relatively regular audio signal is processed by the audio processing chip to provide the inverse audio signal that is opposite to the waveform of the relatively regular audio signal, the bone conduction speaker is configured to convert the inverse audio signal provided by the audio processing chip into a noise cancellation vibration signal;
wherein the power supply module is a disposable thin film battery, and a power-related information signal of the power supply module is transmitted to the portable electronic device through the wireless signal transmission module.

8. The recyclable patch-type bone conduction earphone according to claim 5,
wherein the control module includes a central processing chip, an audio processing chip and a power management chip, and the bone conduction module includes a bone conduction speaker and an audio signal amplifier electrically connected between the bone conduction speaker and the control module:
wherein the audio signal receiving module is a microelectromechanical microphone chip or an electret condenser microphone chip, and the audio signal receiving module is configured to receive an irregular audio signal or a relatively regular audio signal;
wherein, when the audio signal receiving module is configured to receive the irregular audio signal, the irregular audio signal received by the audio signal receiving module is transmitted to the portable electronic device through the wireless signal transmission module;
wherein, when the audio signal receiving module is configured to receive the relatively regular audio signal, the relatively regular audio signal received by the audio signal receiving module is processed by the audio processing chip to provide an inverse audio signal that is opposite to a waveform of the relatively regular audio signal;
wherein the wireless signal transmission module is a Bluetooth chip or a radio frequency identification chip, and the recyclable patch-type bone conduction earphone is wirelessly connected to the portable electronic device that is configured to provide the predetermined audio signal through the wireless signal transmission module;
wherein, when the wireless signal transmission module is configured to receive the predetermined audio signal, the audio signal amplifier is configured to amplify the predetermined audio signal received by the wireless signal transmission module, and the bone conduction speaker is configured to convert the predetermined audio signal amplified by the audio signal amplifier into the predetermined vibration signal;
wherein, when the relatively regular audio signal is processed by the audio processing chip to provide the inverse audio signal that is opposite to the waveform of the relatively regular audio signal, the audio signal amplifier is configured to amplify the inverse audio signal provided by the audio processing chip, and the bone conduction speaker is configured to convert the inverse audio signal amplified by the audio signal amplifier into a noise cancellation vibration signal;
wherein the power supply module is a disposable thin film battery, and a power-related information signal of the power supply module is transmitted to the portable electronic device through the wireless signal transmission module.

9. A recyclable patch-type bone conduction earphone, comprising:
a casing structure including a carrier base and a covering casing disposed on the carrier base;
a circuit substrate detachably disposed on a top portion of the carrier base;
a control module disposed on the circuit substrate and electrically connected to the circuit substrate;
an audio signal receiving module disposed on the circuit substrate and electrically connected to the control module, wherein the audio signal receiving module is configured to receive an environmental audio signal;
a wireless signal transmission module disposed on the circuit substrate and electrically connected to the control module, wherein the wireless signal transmission module is configured for wirelessly receiving a predetermined audio signal provided by a portable electronic device;
a bone conduction module disposed on the circuit substrate and electrically connected to the control module, wherein the bone conduction module is configured to convert the predetermined audio signal received by the wireless signal transmission module into a predetermined vibration signal; and
a power supply module electrically connected to the control module, wherein the power supply module is configured to provide power to the control module, the audio signal receiving module, the wireless signal transmission module and the bone conduction module;
wherein the covering casing has a plurality of through openings corresponding to the audio signal receiving module, and the audio signal receiving module is configured to receive the environmental audio signal through the through openings.

10. The recyclable patch-type bone conduction earphone according to claim 9,
wherein the covering casing is detachably or integrally disposed on the carrier base;
wherein the covering casing has a concave groove for completely accommodating the circuit substrate, the control module, the audio signal receiving module, the wireless signal transmission module and the bone conduction module, and a depth of the concave groove is greater than a total stacking height of the circuit substrate and one of the control module, the audio signal receiving module, the wireless signal transmission module and the bone conduction module;
wherein the carrier base has an adhesive layer disposed on a bottom portion thereof and a removable protective layer attached to the adhesive layer;
wherein the removable protective layer has a covering portion and an extending portion, the covering portion of the removable protective layer is configured to completely cover the adhesive layer, and the extending portion of the removable protective layer is connected to the covering portion and separate from the adhesive layer;
wherein the circuit substrate, the control module, the audio signal receiving module, the wireless signal transmission module and the bone conduction module cooperate with each other to form an electronic assembly structure that is able to be recycled;
wherein the electronic assembly structure is disposed on the top portion of the carrier base through a position-limiting structure located at a bottom portion of the circuit substrate, and the electronic assembly structure does not contact the covering casing;
wherein the control module includes a central processing chip, an audio processing chip and a power management chip, and the bone conduction module includes a bone conduction speaker;
wherein the audio signal receiving module is a microelectromechanical microphone chip or an electret condenser microphone chip, and the audio signal receiving module is configured to receive an irregular audio signal or a relatively regular audio signal;
wherein, when the audio signal receiving module is configured to receive the irregular audio signal, the irregular audio signal received by the audio signal receiving module is transmitted to the portable electronic device through the wireless signal transmission module;
wherein, when the audio signal receiving module is configured to receive the relatively regular audio signal, the relatively regular audio signal received by the audio signal receiving module is processed by the audio processing chip to provide an inverse audio signal that is opposite to a waveform of the relatively regular audio signal;
wherein the wireless signal transmission module is a Bluetooth chip or a radio frequency identification chip, and the recyclable patch-type bone conduction earphone is wirelessly connected to the portable electronic device that is configured to provide the predetermined audio signal through the wireless signal transmission module;
wherein, when the wireless signal transmission module is configured to receive the predetermined audio signal, the bone conduction speaker is configured to convert the predetermined audio signal received by the wireless signal transmission module into the predetermined vibration signal;
wherein, when the relatively regular audio signal is processed by the audio processing chip to provide the inverse audio signal that is opposite to the waveform of the relatively regular audio signal, the bone conduction speaker is configured to convert the inverse audio signal provided by the audio processing chip into a noise cancellation vibration signal;
wherein the power supply module is a disposable thin film battery, and a power-related information signal of the power supply module is transmitted to the portable electronic device through the wireless signal transmission module.
